(19) United States
(12) Patent Application Publication
(10) Pub. No.: US 2017/0304788 A1
(43) Pub. Date: Oct. 26, 2017

(54) MIXER TOOL

(71) Applicant: Rick GROVER, Haleiwa, HI (US)

(72) Inventor: Rick GROVER, Haleiwa, HI (US)

(21) Appl. No.: 15/482,948

(22) Filed: Apr. 10, 2017

Related U.S. Application Data
(60) Provisional application No. 62/326,910, filed on Apr. 25, 2016.

(51) Int. Cl. B01F 7/00; B01F 13/00; B44D 3/08; B01F 15/00

(52) U.S. Cl. CPC B01F 7/00566; B44D 3/08; B01F 13/002; B01F 15/00538; B01F 7/0005; B01F 7/00683; B01F 7/00633; B01F 7/001; B01F 2215/005

(57) ABSTRACT

An apparatus is disclosed for mixing substances, such as paint. The apparatus includes an elongate member with a plurality of openings formed within it. A filament is threaded through the openings creating bights between openings. The bights and ends of the filament sweep through the substance when the elongate member is rotated, which works to mix the substance.

### CROSS-REFERENCE TO RELATED APPLICATIONS

The present application claims the priority under 35 U.S.C. §119 or the Paris Convention from U.S. Provisional Patent App. No. 62/326,910, filed Apr. 25, 2016, which is hereby incorporated by reference in its entirety.

### BACKGROUND

Typical economical mixers, such as paint stirrers, are manually operated. Such mixers require quite a bit of effort to properly mix viscous liquids. And manual mixing typically requires a considerable amount of time. Furthermore, such mixers are often relatively fragile considering the forces and durations needed to mix viscous fluids. Thus, such mixers often do not survive prolonged use and, once broken, are typically discarded.

Thus, there exists a need for a mixer that reduces the effort and time required to mix substances, that is durable, and that may be repaired.

### BRIEF DESCRIPTION OF THE DRAWINGS

FIG. 1 is a top view of a mixer according to an embodiment.

FIG. 2A is a right side view of an element of a mixer according to an embodiment.

FIG. 2B is a front view of the element of a mixer of FIG. 2A.

FIG. 3A is a top view of a mixer according to an embodiment.

FIG. 3B is a perspective view of the mixer of FIG. 3A.

FIG. 4A is a right side view of an element of a mixer according to an embodiment.

FIG. 4B is a front view of the element of a mixer of FIG. 4A.

FIG. 5A is right side view of an element of a mixer according to an embodiment.

FIG. 5B is a front view of the element of a mixer of FIG. 5A.

### BRIEF SUMMARY

In an embodiment, an apparatus may include an elongate member having a first end, a second end, a longitudinal axis, and a first section at the first end. The first section may be used to hold the apparatus, e.g., the first section may be held by the chuck of a drill. The first section may have either a circular cross-section or a regular-hexagonal cross-section about the longitudinal axis. The circular cross-section may have a constant diameter for the entirety of the circular cross-section, or the regular-hexagonal cross-section may have a constant long diagonal for the entirety of the regular-hexagonal cross-section. The embodiment further includes one or more openings passing through the elongate member with a filament disposed in each opening and extending from the opening on one or both ends of the opening. In an embodiment, each individual opening has within it an individual filament, the filament extending from one or both ends of the opening so that, when the embodiment is immersed in a substance and rotated, e.g., by a drill, the extended ends of the filament sweep through a volume and may mix the substance. In an embodiment, the filament is continuous and is threaded from one opening to the next creating a bight (or “loop”) between adjacent openings. The bight or bights extend from the opening so that, when the embodiment is immersed in a substance and rotated, e.g., by a drill, the bight or bights sweep through a volume and may mix the substance. In an embodiment, a filament is threaded through a subset of the openings, e.g., three openings, which works to retain the filament. In the embodiment, the filament ends extend away from the opening and the bights, between openings, run against or close to the elongate member. In the embodiment, when the embodiment is immersed in a substance and rotated, e.g., by a drill, the ends of the filament extending from the openings may mix the substance. In an embodiment, the filament is flexible such that the apparatus may be inserted through an opening into a volume to mix a substance contained in the volume—the filament flexing toward the elongate member to pass through the opening.

In an embodiment, an apparatus may include an elongate member having a first end, a second end, and a longitudinal axis. Within the elongate member the embodiment may include a plurality of openings with each opening passing through the elongate member and a filament threaded through each of the plurality of openings. In an embodiment, the filament is continuous and is threaded from one opening to the next creating a bight (or “loop”) between adjacent openings. In an embodiment, the ends of the filament extend from the openings, while the bights between openings lay against or are close to the elongate member such that, when the embodiment is immersed in a substance and rotated, e.g., by a drill, the extended ends may mix the substance. In an embodiment, the bight or bights extend from the opening so that, when the embodiment is immersed in a substance and rotated, e.g., by a drill, the bight or bights sweep through a volume and may mix the substance. In an embodiment, the elongate member includes a second plurality of openings with a second filament threaded from one opening of the second plurality to the next opening of the second plurality so that, when the embodiment is immersed in a substance and rotated, e.g., by a drill, the bights (if extended), the extended ends, or both may mix the substance.

In an embodiment, a system for mixing includes a motor having a first longitudinal axis and an elongate member having a first end, a second end, and a second longitudinal axis. The elongate member further includes a first opening passing through the elongate member and a first filament disposed within the first opening, the first filament extending from at least one side of the first opening, wherein the elongate member is coupled to the motor such that the first and second longitudinal axes are collinear. In an embodiment, the system may include an elongate member, with one or more openings and one or more filaments, with the filaments and holes configured as described in any other embodiment.

### DETAILED DESCRIPTION

An embodiment provides a mixer tool with a drill bit having a series of openings formed along the longitudinal axis. A filament, disposed in the openings and extending from the openings, sweeps through an arc when the bit is rotated about the longitudinal axis. Such movement of the filament may be used to quickly mix liquids when clamped in the chuck of a hand drill. For example, the several embodiments may be used for mixing paint. Also, the several embodiments may be used for purposes other than mixing, e.g., agitating, aerating, liquefying, or changing the viscosity of other (perhaps already-mixed) substances. This disclosure should not be construed to limit the uses for the claimed subject matter.

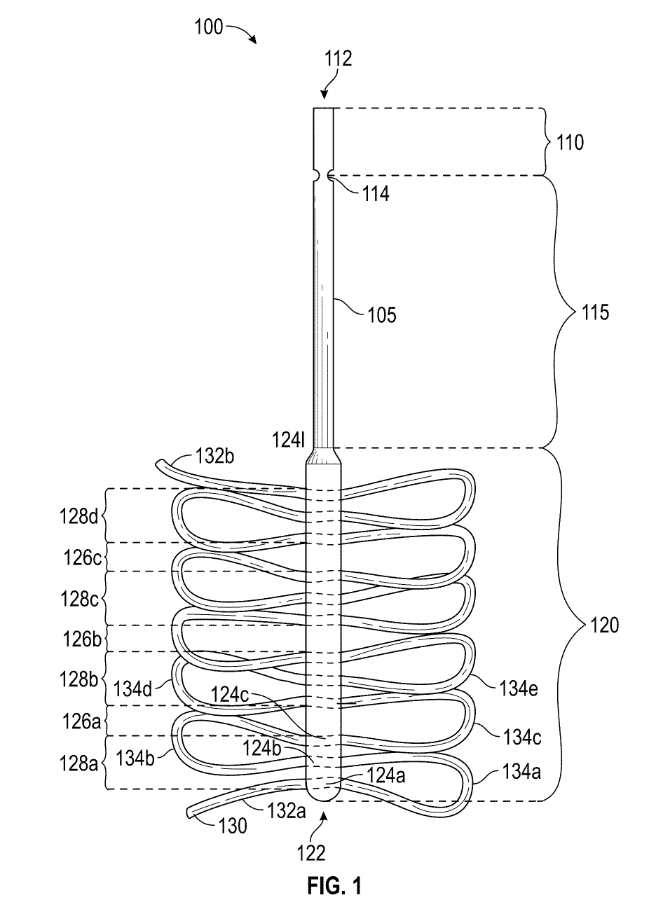

FIG. 1 is a top view of a mixer 100 according to an embodiment. In FIG. 1, mixer 100 includes an elongate member 105 and a filament 130. Elongate member 105 includes a chuck section 110, a shaft section 115, and a filament section 120. The longitudinal axes of chuck section 110, shaft section 115, and filament section 120 may be collinear to reduce vibration when mixer 100 is rotated.

Chuck section 110 is dimensioned to be received by the chuck of a drill. As such, chuck section 110 will typically be either cylindrical with a constant diameter (i.e., a chuck end 112 may be circular), or hexagonal with a constant long diagonal (i.e., chuck end 112 may be hexagonal). Chuck section 110 may have a demarcation notch 114 at the transition from chuck section 110 to shaft section 115. Shaft section 115 may be optional, or may have an arbitrary length chosen to create distance between chuck section 110 and filament section 120. The length may be chosen to allow a user to, e.g., immerse the filament section 120 to a depth greater than the length of filament section 120 without also having to immerse the chuck or hand drill, or to distance the chuck and attached hand drill from potential splattering.

Filament section 120 has a plurality of openings 124a, 124b, 124c . . . 124l formed within it. The embodiment depicts twelve openings, but in other embodiments the number of openings and the dimensions of filament section 120 may be decreased or increased to satisfy the need to mix liquids in shallower or deeper containers, or to accommodate relatively thicker or thinner filaments. In the embodiment, openings 124a . . . 124l are formed through and perpendicular to the longitudinal axis of filament section 120 and are parallel to each other. In other embodiments openings 124a . . . 124l may be offset from the longitudinal axis (i.e., not pass through the longitudinal axis) and may also not be parallel to each other.

In the embodiment of FIG. 1, filament 130 is disposed within each of openings 124a . . . 124l, with filament ends 132a, 132b extending from filament section 120. As disposed within openings 124a, . . . 124l, filament 130 creates bights (or “loops”), e.g., bights 134a, 134b, 134c, 134d, and 134e, between each pair of adjacent openings. In the embodiment, both filament ends 132a, 132b and bights 134a, et seq., extend away from filament section 120. Thus, when elongate member 105 is rotated about its longitudinal axis, filament ends 132a, 132b and bights 134a, et seq., sweep through an arc. Such action may be used to, e.g., mix a substance, such as paint.

In an embodiment, openings 124a . . . 124l may be circular holes or other non-circular openings. For example, openings 124a . . . 124l may be slots. In such case, the slot-shaped openings 124a . . . 124l may be dimensioned to allow filament 130 to be threaded through, yet slot-shaped openings 124a . . . 124l may also compress filament 130 and thereby work to retain or stabilize the position of filament 130.

In an embodiment, openings 124a . . . 124l may not be parallel. For example, in an embodiment neighboring openings, e.g., openings 124a and 124b, may be rotated about the longitudinal axis of elongate member 105 with respect to each other. Thus, opening 124a, when viewed from elongate member end 122 and using a clock face as reference, may run from 3 o'clock to 9 o'clock and opening 124a may run from 4 o'clock to 10 o'clock. Such rotation causes bights 134a, et seq., to be distributed around filament section 120 when viewed from elongate member end 122. A benefit of such distribution is that bights 134a, et seq., may fold down toward chuck end 112 without hitting as many other bights in the process. An embodiment with such distributed bights may be inserted through an opening with a smaller diameter than the embodiment of FIG. 1. So, for example, since smaller animals tend to have smaller openings in the skull for the spinal column, the embodiment with distributed bights could be used to liquefy and remove the brains from the skull cavities of a greater size-range of animals.

In an embodiment, bights may be created by threading filament 130 through holes 124a . . . 124l in a different order, e.g., by threading from opening 124a to opening 124c, then to opening 124b, etc.

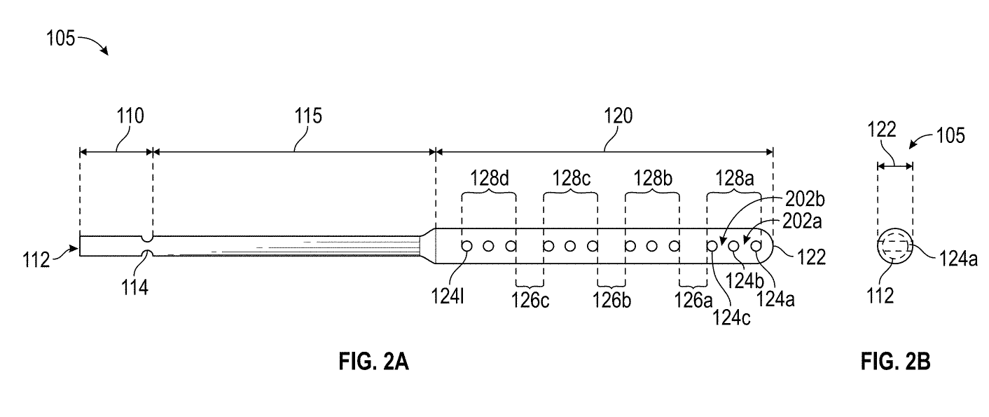

FIG. 2A is a right side view of elongate member 105 of FIG. 1. FIG. 2a depicts openings 124a . . . 124l separated into opening groups 128a, 128b, 128c, and 128d, each group including three openings. Opening groups are separated by a group distance 126a, 126b, and 126c, where group distances 126a, 126b, and 126c are equal. Within each group the individual openings are separated by the same distance, e.g., opening distances 202a and 202b, where opening distances 202a and 202b are equal.

FIG. 2B is a front view of elongate member 105 of FIG. 2A. FIG. 2B illustrates that elongate member end 122 may have a greater diameter than chuck end 112. FIG. 2B further illustrates that openings 124a . . . 124l are parallel and through the longitudinal axis of elongate member 105.

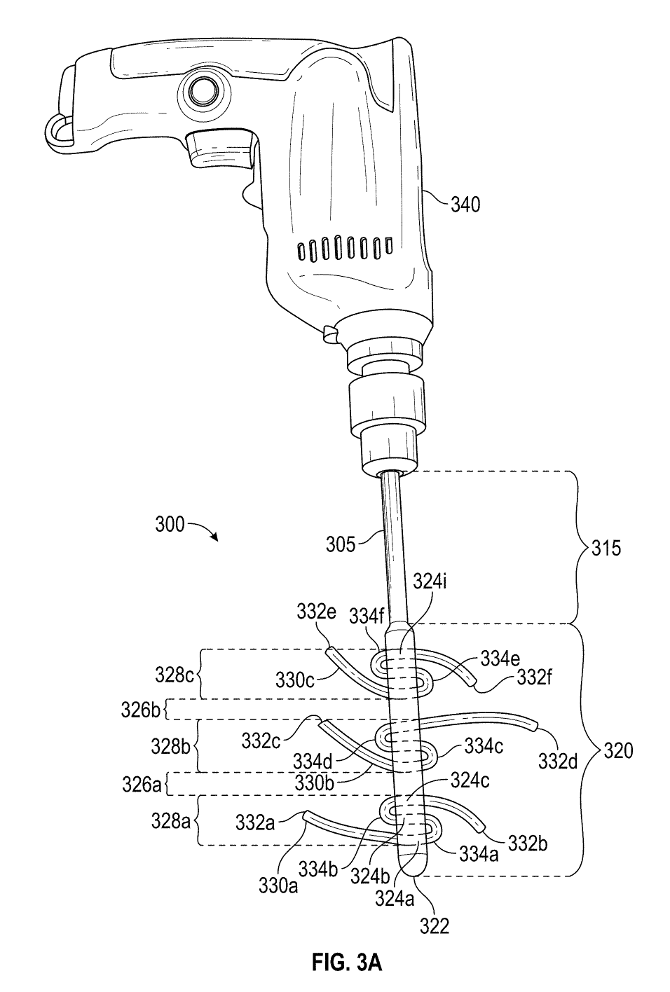

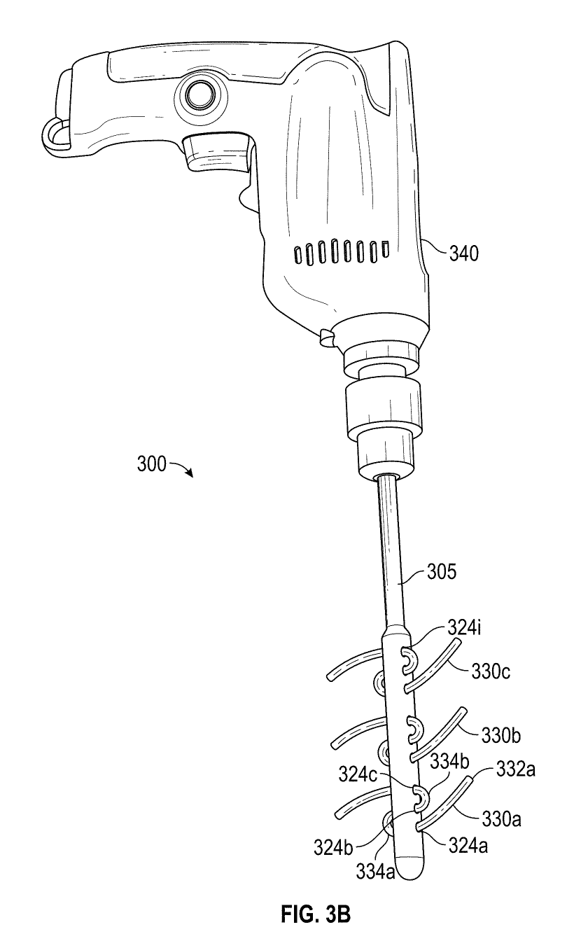

FIG. 3A is a top view of a mixer 300 according to an embodiment. In FIG. 3A, an elongate member 305 is held in the chuck of a hand drill 340. Elongate member 305 includes filaments 330a, 330b, and 330c. Elongate member 305 includes a chuck section (FIG. 3B, element 322), a shaft section 315, and a filament section 320. The longitudinal axes of the chuck section (FIG. 3B, element 322), shaft section 315, and filament section 320 may be collinear to reduce vibration when elongate member 305 is rotated at speed by drill 340.

Shaft section 315 may be optional, or may have an arbitrary length chosen to create distance between chuck section (FIG. 3B, element 322) and filament section 320. The length may be chosen to allow a user to, e.g., immerse the filament section 320 to a depth greater than the length of filament section 320 without also having to immerse the chuck or hand drill, or to distance the chuck and attached hand drill from potential splattering.

Filament section 320 has a plurality of openings 324a, 324b, 324c . . . 324i formed within it. The embodiment depicts nine openings, but in other embodiments the number of openings and the dimensions of filament section 120 may be decreased or increased to satisfy the need to mix liquids in shallower or deeper containers, or to accommodate relatively thicker or thinner filaments. In the embodiment, openings 324a . . . 324i are formed through and perpendicular to the longitudinal axis of filament section 320 and are parallel to each other. In other embodiments openings 324a . . . 324i may be offset from the longitudinal axis (i.e., not pass through the longitudinal axis) and may also not be parallel to each other.

In the embodiment of FIG. 3A, filaments 330a, 330b, and 330c are disposed within opening groups 328a, 328b, and 328c, respectively. That is, filament 330a is threaded through openings 324a, 324b, and 324c; leaving filament ends 332a, 332b extended away from filament section 320. Filaments 330b and 330c are threaded similarly. As disposed within openings 324a . . . 324i, filaments 330a, 330b, 330c still create bights (or “loops”), e.g., bights 334a . . . 334f, between each pair of adjacent openings. However, in the embodiment, bights 334a . . . 334f are against or close to filament section 320 so that, relatively, filament ends 332a . . . 332f extend away from filament section 320. Thus, when elongate member 305 is rotated about its longitudinal axis, filament ends 332a . . . 332f sweep through an arc. Such action may be used to, mix a substance, e.g., paint. In an embodiment, bights 334a . . . 334f are enlarged so that they extend further away from filament section 320. In this manner, by changing the distance that one or more of filaments ends 332a . . . 332f and bights 334a . . . 334f extend away from filament section 320, the volume swept through by the sum of filaments 330a, 330b, and 330c during one rotation of elongate member 305 may be changed. Thus the embodiment provides a way to increase or decrease the mixing effect of the embodiment that is independent from drill speed or filament thickness.

In an embodiment, openings 324a . . . 324i may be circular holes or other non-circular openings. For example, openings 324a . . . 324i may be slots. In such case, the slot-shaped openings 324a . . . 324i may be dimensioned to allow filaments 330a, 330b, and 330c to be threaded through, while slot-shaped openings 324a . . . 324i may also partially compress filaments 330a, 330b, 330c and thereby work to retain or stabilize the position of filaments 330a, 330b, and 330c.

In an embodiment, openings 324a . . . 324i may not be parallel. For example, in an embodiment neighboring openings, e.g., openings 324a and 324b, may be rotated about the longitudinal axis of elongate member 305 with respect to each other. Thus, opening 324a, when viewed from elongate member end 322 and using a clock face as reference, may run from 3 o'clock to 9 o'clock and opening 324b may run from 4 o'clock to 10 o'clock. Such rotation causes bights 334a, et seq., to be distributed around filament section 320 when viewed from elongate member end 322. A benefit of such distribution is that filament ends 332a . . . 332f may fold down toward drill 340 without hitting as many other filament ends in the process. An embodiment with such distributed bights may be inserted through an opening with a smaller diameter than the embodiment of FIG. 3A.

FIG. 3B is a perspective view of the mixer of FIG. 3A. In FIG. 3B, it can be seen that bights 334a . . . 334n may extend some distance from elongate member 305. However, because bights 334a . . . 334n do not extend nearly as far as filament ends 332a . . . 332f the majority of the volume swept by the embodiment is due to filament ends 332a, . . . 332f.

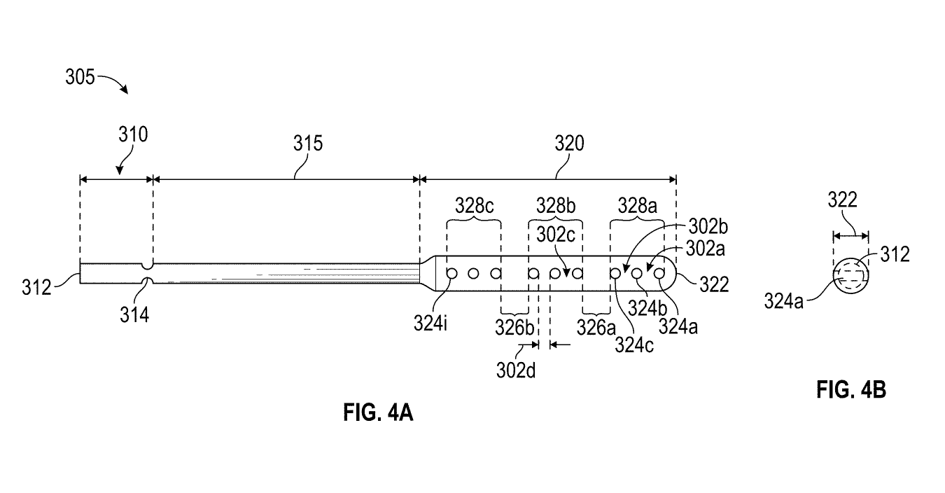

FIG. 4A is a right side view of elongate member 305 of FIG. 3A. FIG. 4A depicts openings 324a, . . . 324i separated into opening groups 328a and 328b, and 328c, each group including three openings. Opening groups are separated by a group distance 326a and 326b, where group distances 326a and 326b are equal. Within each group the individual openings are separated by the same distance, e.g., opening distances 302a and 302b, where opening distances 302a and 302b are equal.

FIG. 4B is a front view of elongate member 305 of FIG. 4A. FIG. 4B illustrates that elongate member end 322 has a greater diameter than chuck end 312. FIG. 4B further illustrates that openings 324a . . . 324i are parallel and through the longitudinal axis of elongate member 305.

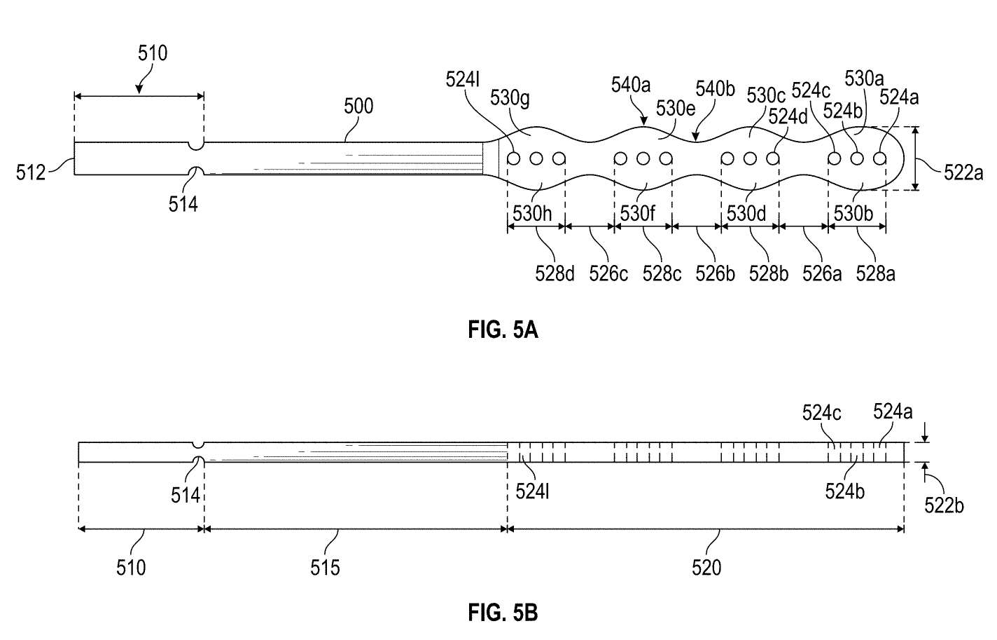

FIGS. 5A and 5B depict an embodiment of an elongate member 500. FIG. 5A is right side view of elongate member 500. FIG. 5B is a top view of elongate member 500. In FIG. 5A, elongate member 500 includes a chuck section 510, a shaft section 515, and a filament section 520. Chuck section 510 and shaft section 515 may be similar to the chuck sections and shaft sections described previously with reference to FIGS. 1-4B. Filament section 520 has a plurality of openings 524a, 524b, 524c . . . 524n formed within it. The embodiment depicts twelve openings, but in other embodiments the number may be decreased or increased to satisfy the need to mix liquids in shallower or deeper containers, or to accommodate relatively thicker or thinner filaments. In the embodiment, openings 524a . . . 524n are formed through and perpendicular to the axis of symmetry of filament section 120 and are parallel to each other. In other embodiments openings 524a . . . 524n may be offset from the axis of symmetry (i.e., not pass through the axis of symmetry) and may also not be parallel to each other.

In FIG. 5A, openings 524a . . . 524n separated into opening groups 528a, 528b, 528c, and 528d, each group including three openings. Opening groups are separated by a group distance 526a, 526b, and 526c, where group distances 526a, 526b, and 526c are equal. Within each group the individual openings are separated by the same distance, as discussed above.

In an embodiment, the distances between individual openings and between any groups of openings may be varied arbitrarily.

In the embodiment of FIGS. 5A and 5B, filament section 520 has flat right and left sides with a maximum width 522a and a thickness 522b. Thickness 522b is equal to diameter 512 of chuck section 510 and shaft section 515. Maximum width 522a is created by the addition of lobes 530a, 530b, 530c . . . 530h to either side of openings 524a . . . 524n. For example, lobes 530a and 530b are on opposite sides of opening group 528a. Lobes 530a . . . 530h extend away from the axis of symmetry of filament section 520, in so doing lobes 530a . . . 530h increase the volume swept by the rotation of filament section 520. In this manner, lobes 530a . . . 530h increase the mixing action contribution of elongate member 500 itself. The longitudinal axes of chuck section 510 and shaft section 515, and the axis of symmetry of filament section 520 may be collinear to reduce vibration when elongate member 500 is rotated. FIG. 5B further illustrates that openings 524a . . . 524n are parallel.

In an embodiment, each lobe may be defined by an outer radius 540a and an inner radius 540b.

In an embodiment, a filament or filaments may be disposed in openings 524a . . . 524n of FIGS. 5A and 5B as described previously with reference to FIGS. 1-4B. Similarly, in embodiments, openings 524a . . . 524n may be other than circular, may be other than parallel, and may be rotated about the axis of symmetry, all as described with reference to FIGS. 1-4B.

In an embodiment the filament material may include: string, wire, monofilament fishing line, co-filament line, braided line, thermally fused line, fluorocarbon line, weed trimmer line, and cable ties, all of various thicknesses and strengths. Examples of the material of the line that may be used including nylon, polyvinylidene fluoride (PVDF, also called fluorocarbon), polyethylene, Dacron® and Dyneema® (UHMWPE). The length, material, and weight of the line may be determined based upon the application. Factors that may determine what line is chosen for a given application include: breaking strength, limpness, stretch, abrasion resistance, and durability. Braided, co-filament, and thermally fused lines are also known as “superlines” for their small diameter, lack of stretch, and great strength relative to standard nylon monofilament lines. Braided, thermally fused, and chemically fused varieties of “superlines” are now readily available. The mixer tool may be used with both single- and multi-strands threaded through the openings. Softer line may be used, such as string or yarn for uses that require more flexibility in order to fit within a smaller space or to prevent breakage of the workpiece.

An aspect of various embodiments is that the filament may be replaced for a number of reasons, e.g., if worn, fatigued, broken, or not suitable for use with a particular substance. Thus, various embodiments may be repaired economically and may also be adapted to different substances.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. An apparatus for mixing comprising:
an elongate member having a first end, a second end, a longitudinal axis, and a first section at the first end, the first section having a circular cross-section or regular-hexagonal cross-section about the longitudinal axis, the circular cross-section having a first diameter for the entirety of the circular cross-section, or the regular-hexagonal cross-section having a first long diagonal for the entirety of the regular-hexagonal cross-section;
at least one opening formed through the elongate member; and
a separate filament corresponding to each at least one opening, each separate filament disposed within the corresponding opening, each separate filament extending from at least one side of the at least one opening.

2. The apparatus of claim 1 wherein the elongate member has a circular cross-section about the longitudinal axis between the first section and the second end, the elongate member further includes a second section between the first section and the second end, and includes a third section between the second section and the second end, and wherein each at least one opening is included in the third section.

3. The apparatus of claim 2, wherein each separate filament is flexible.

4. The apparatus of claim 3 wherein each separate filament includes: string, wire, monofilament fishing line, co-filament line, braided line, thermally fused line, fluorocarbon line, weed trimmer line, or a cable tie.

5. The apparatus of claim 3 wherein each separate filament, when disposed within each at least one opening, is more flexible in the direction of the longitudinal axis than in the direction requiring rotation about the longitudinal axis.

6. The apparatus of claim 5 wherein the separate filament is planar and relatively more flexible about an axis that is parallel to the plane of the filament and relatively less flexible about an axis that is perpendicular to the plane of the filament.

7. The apparatus of claim 1, wherein the at least one opening includes a plurality of openings, each opening of the plurality offset from an adjacent opening by being rotated about the longitudinal axis relative to the adjacent opening.

8. An apparatus for mixing comprising:
an elongate member having a first end, a second end, and a longitudinal axis;
a first plurality of openings, each opening of the first plurality formed through the elongate member; and
a first filament threaded through each of the first plurality of openings.

9. The apparatus of claim 8 wherein each of the first plurality of openings passes from a first side of the elongate member through to a second side of the elongate member, the apparatus further including:
a second plurality of openings, each opening of the second plurality passing from the first side of the elongate member through to the second side of the elongate member.

10. The apparatus of claim 8 wherein the first plurality of openings includes a first opening, a second opening, and a third opening, and the first filament extends from the first opening a first distance, passes through the first, second, and third openings, and extends from the third opening a second distance from the elongate member.

11. The apparatus of claim 10 wherein the first filament, after exiting from the first opening and before entering the second opening, forms a first bight, and the first filament, after exiting from the second opening and before entering the third opening, forms a second bight.

12. The apparatus of claim 10 wherein the first filament is situated next to the third section between the first opening and the second opening, and the first filament is situated next to the third section between the second opening and the third opening.

13. The apparatus of claim 12 wherein each opening is disposed through the third section in a first direction, and the third section further includes a first lobe and a second lobe, the first and second lobes distributed on opposing sides of the third section and extending from the third section perpendicularly to the first direction.

14. The apparatus of claim 13 wherein the first lobe is a first distance from the second end and the second lobe is a second distance from the second end and the first distance is different from the second distance.

15. The apparatus of claim 8 further including a second plurality of openings wherein the first plurality of openings includes a first opening, a second opening, and a third opening, and the second plurality of openings includes a fourth opening, a fifth opening, and a sixth opening, and the first filament extends from the first opening a first distance, passes through the first, second, third, fourth, fifth, and sixth openings, and extends from the sixth opening a second distance, and the first filament:
(i) after exiting the first opening and before entering the second opening, forms a first bight,
(ii) after exiting the second opening and before entering the third opening, forms a second bight,
(iii) after exiting the third opening and before entering the fourth opening, forms a third bight,
(iv) after exiting the fourth opening and before entering the fifth opening, forms a fourth bight, and
(v) after exiting the fifth opening and before entering the sixth opening, forms a fifth bight.

16. The apparatus of claim 15 wherein each opening is disposed in a first direction through the third section, and the third section further includes a first lobe and a second lobe distributed on opposing sides of the third section about the first plurality of openings, and includes a third lobe and a fourth lobe distributed on opposing sides of the third section about the second plurality of openings, the first, second, third, and fourth lobes extending from the third section perpendicularly to the first direction.

17. An apparatus for mixing comprising:
a motor having a first longitudinal axis; and
an elongate member having a first end, a second end, a second longitudinal axis, a first opening passing through the elongate member, and a first filament disposed within the first opening, the first filament extending from at least one side of the first opening, wherein the elongate member is coupled to the motor such that the first and second longitudinal axes are collinear.

18. The apparatus of claim 17, wherein the elongate member further comprises:
a first plurality of openings including the first opening, a second opening, and a third opening, each opening of the first plurality formed through the elongate member, and wherein the first filament extends from a first side of the first opening a first distance and is disposed within the first, second, and third openings.

19. The apparatus of claim 18 further including a second plurality of openings including a fourth opening, a fifth opening, and a sixth opening, wherein after exiting the third opening, the first filament is also disposed in the fourth, fifth, and sixth openings, and extends from the sixth opening a second distance, and the first filament:
(i) after exiting the first opening and before entering second opening, forms a first bight extending away from the elongate member,
(ii) after exiting the second opening and before entering the third opening, forms a second bight extending away from the elongate member,
(iii) after exiting the third opening and before entering the fourth opening, forms a third bight extending away from the elongate member,
(iv) after exiting ugh the fourth opening and before entering the fifth opening, forms a fourth bight extending away from the elongate member, and
(v) after exiting the fifth opening and before entering the sixth opening, forms a fifth bight extending away from the elongate member.

20. The apparatus of claim 19 where each opening is disposed in a first direction through the elongate member, and elongate member further includes a first lobe and a second lobe distributed on opposing sides of the elongate member about the first plurality of openings, and includes a third lobe and a fourth lobe distributed on opposing sides of the elongate member about the second plurality of openings, the first, second, third, and fourth lobes extending from the elongate member perpendicularly to the first direction.
